(19) United States
(12) Patent Application Publication
(10) Pub. No.: US 2021/0009287 A1
(43) Pub. Date: Jan. 14, 2021

(54) Magnetic Flux Engine for Spacecraft Propulsion

(71) Applicant: Encarnacion Gonzalez, Alice, TX (US)

(72) Inventor: Encarnacion Gonzalez, Alice, TX (US)

(21) Appl. No.: 16/912,801

(22) Filed: Jun. 26, 2020

Related U.S. Application Data
(60) Provisional application No. 62/872,115, filed on Jul. 9, 2019.

(51) Int. Cl. B64G 1/40; B64G 1/44; B64G 1/42

(52) U.S. Cl. CPC B64G 1/409; B64G 1/422; B64G 1/443

(57) ABSTRACT

As is scientifically well know magnetic flux is a physical force (i.e. the Lorentz force and Ampere's force). The invention utilizes a plurality of electromagnetic and or plasma coils to create high pressure, high velocity magnetic flux directed through variable exhaust nozzles or a cone shaped electrical coil to create thrust for spacecraft.

### CROSS-REFERENCE TO RELATED APPLICATIONS

This application takes benefit of U.S. Prov. Pat. App. No. 62/872,115 filed Jul. 9, 2019 which is included, in its entirety, by reference.

### FIELD OF THE INVENTION

This invention relates to spacecraft propulsion. As is scientifically well know magnetic flux is a physical force (i.e. the Lorentz force and Ampere's force). This invention utilizes a plurality of electromagnetic and or plasma coils to create high pressure, high velocity magnetic flux directed through variable exhaust nozzles or a cone shaped coil to create thrust for spacecraft.

### BACKGROUND OF THE INVENTION

For many years extensive research has been done by private and government entities directed towards creating practical long-term infinite distance propulsion systems for spacecraft. Electromagnetic flux exists throughout the known universe. Accordingly, a spacecraft propulsion system that utilizes electromagnetic flux by directing magnetic flux is desirable.

### SUMMARY OF THE INVENTION

The present invention relates to spacecraft propulsion systems which utilize magnetic flux as a physical force to propel spacecraft through the vacuum of outer space. The system uses a plurality of coils of electrically conductive material, super conducting material, or plasma coils designed to create high density, high magnetic flux pressure, high velocity electromagnetic flux fields routed through a variable exhaust nozzle or a cone shaped coil to create thrust.

The system may initially be powered by banks of capacitors or super capacitors. The magnetic fields initially produced will interact with a plurality of coils designed to create electric power for the system. Solar power or a miniature nuclear reactor may optionally power the system.

This invention utilizes a plurality of electromagnetic and or plasma coils to produce high pressure, high velocity magnetic flux (Lorentz force, Ampere force) to create thrust for spacecraft.

### BRIEF DESCRIPTION OF THE DRAWINGS

FIG. 1 shows a side cutaway view of a magnetic flux engine 99 for spacecraft propulsion.

FIG. 2 shows a detailed side cutaway view of a magnetic flux engine 99 with flux pressure controllers 105 at both ends.

FIG. 3 shows a diagonal view of the optional two separate halves of the inner central conduit 103 with retainer rings 110 and a flux pressure controller 105.

FIG. 4a shows a diagonal view of inner central conduit 203 with two formed, unwound pressure controllers 210 and 220 affixed.

FIG. 4b shows a detailed side cutaway view of inner central conduit 203 with two formed, wound pressure controllers 210 and 220 affixed.

FIG. 5 shows a detailed side cutaway view of inner central conduit 303 with two formed, wound pressure controllers 310 and 320 affixed.

FIG. 6a shows a detailed side cutaway view of two formed, wound pressure controllers 410 and 420 wherein one is concentrically enclosed in the other.

FIG. 6b shows detailed side cutaway view of an alternative embodiment using a single formed, wound pressure controller 420.

### DETAILED DESCRIPTION OF THE INVENTION

The invention is not limited to the embodiments shown which only represent examples of the current invention.

FIG. 1 shows a side cross-sectional cutaway view of a magnetic flux engine 99 for spacecraft propulsion. The system uses a plurality of coils of electrically conductive material 102 and 104, super conducting material, or plasma coils designed to create high density, high magnetic flux pressure 100, high velocity electromagnetic flux fields routed through a variable exhaust nozzle 107 or a cone shaped coil to create thrust. The present invention shows a plurality of different layered materials 101, 102, 103, 104, and 105. Inner central conduit 103 may be constructed of high permeability magnetic material. Inner central conduit 103 also shows a flux pressure controller 105 with an inner electric coil 104 that may be used to create a controllable counter magnetic field to create magnetic flux pressure. Also shown are venturi acceleration coils 106a, 106b, and 106c, variable exhaust nozzle 107 or a cone shaped coil, and a plurality of power coils 108 that will interact with magnetic flux 100 designed to produce electric power. Also shown is a layer of electrical conductors 102 and or super conductors, that, when energized will create and/or draw in high density, high velocity magnetic flux 100, through inner central conduit 103, through high velocity venturi 106 and its associated venturi acceleration coils 106a, 106b, and 106c, and through variable exhaust nozzle 107 or a cone shaped electrical coil constructed of non-ferrous magnetic material designed to deflect and/or create high pressure, high velocity magnetic flux thrust. Those having skill in the art will recognize that embodiments of the invention may be constructed with multiple layers of electrical conductors 102 and or super conductors. Also shown is an outer layer 101 constructed of non-ferrous magnetic material designed to contain high velocity magnetic flux 100 and prevent magnetic flux leakage.

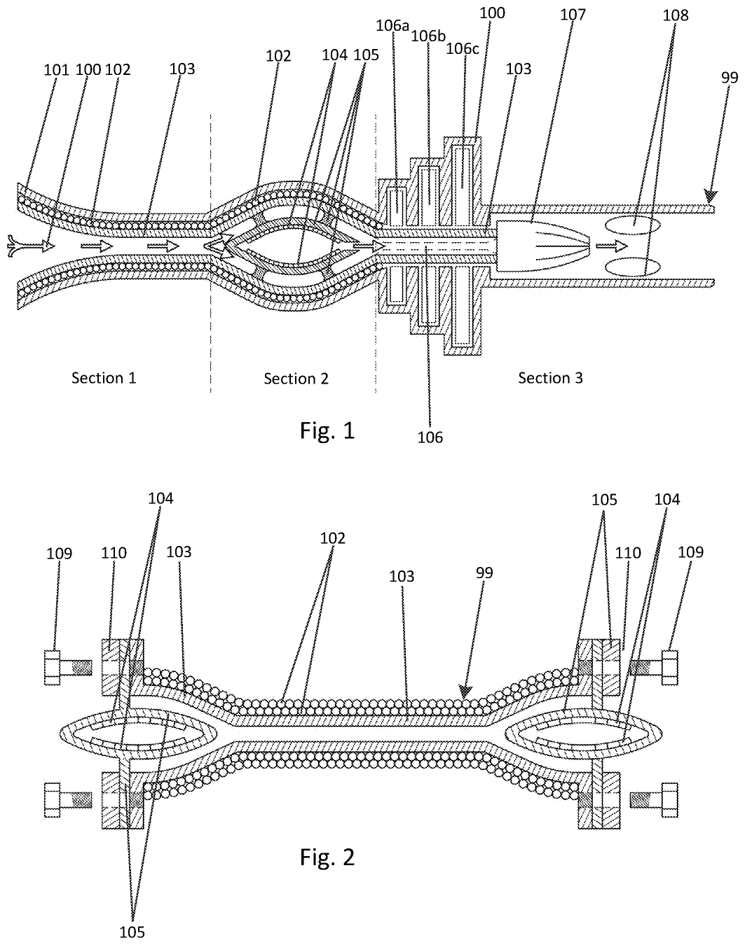

Referring now to FIG. 2, the diagrams show a side cutaway view of an alternative embodiment of a magnetic flux engine 99 The present invention is designed to create high pressure, high velocity magnetic flux for spacecraft propulsion. Inner central conduit 103 is constructed of high and/or ultrahigh permeability magnetic material including, but not limited to, iron based composite nanocrystalline foil, or nickel-plated neodymium composites. Inner central conduit 103 is wrapped with multiple layers of electrical conductors 102 and or super conductors such that when energized creates and/or draws in high density, high pressure, high velocity magnetic flux through the inner central conduit 103 in either direction depending on the polarity of electric power applied to electrical conductors 102. Also shown are flux pressure controllers 105 located at both ends with inner electric coils 104 to create counter electric fields to create controllable magnetic flux pressure and velocities. Optionally, inner central conduit 103 may be constructed of separate portions and joined together by outer retainer rings 110 located at both ends.

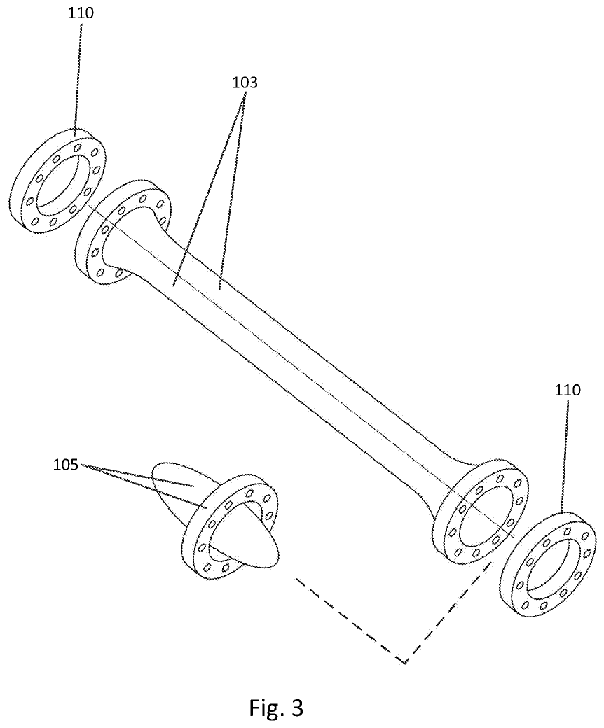

Referring now to FIG. 3, the diagram shows a partially disassembled diagonal view of the optional two separate halves of the inner central conduit 103 with retainer rings 110 and a flux pressure controller 105. Note that the inner central conduit 103 may be manufactured monolithically or in two or more pieces.

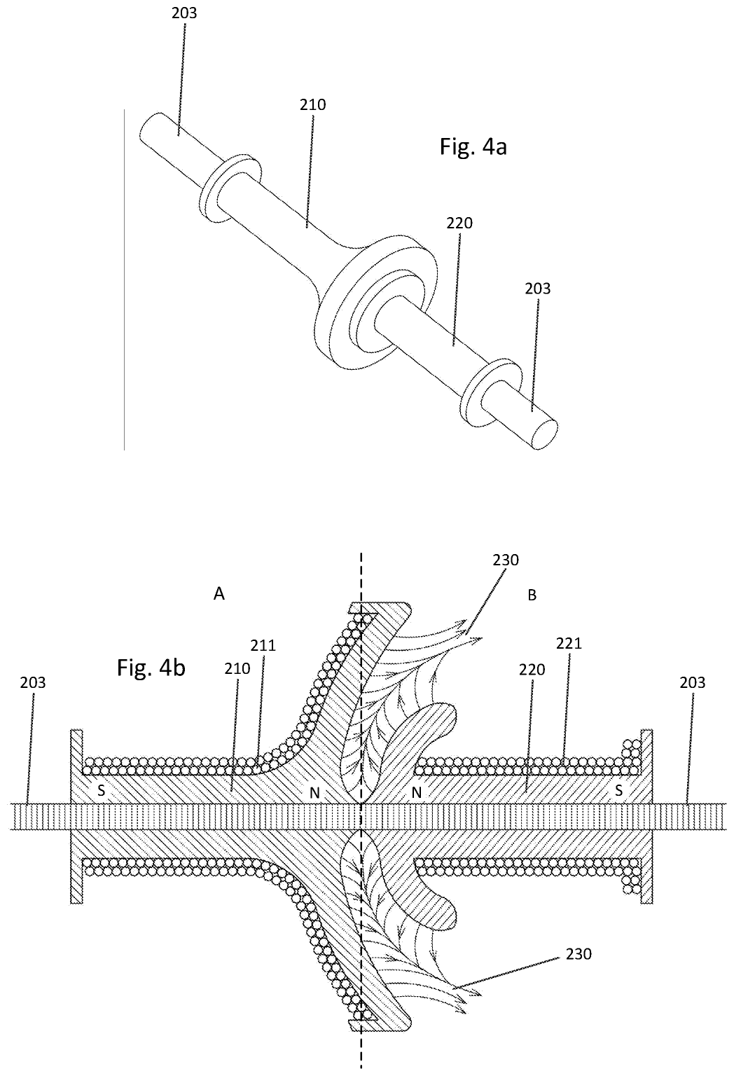

Referring now to FIG. 4a, the diagram shows inner central conduit 203 with two formed, unwound pressure controllers 210 and 220 affixed. Note that inner central conduit may be threaded so that pressure controllers 210 and 220 may be placed at different locations with respect to one another on inner central conduit 203.

Referring now to FIG. 4b, the diagram shows a side cutaway view of inner central conduit 203 with two formed, wound pressure controllers 210 and 220 affixed. Inner central conduit 203 may be threaded so that pressure controllers 210 and 220 may be placed at different locations with respect to one another on inner central conduit 203. Alternately, pressure controllers 210 and 220, may be electrically, electromechanically, or hydraulically configured to be placed at different locations with respect to one another on inner central conduit 203. Inner center conduit 203 may be constructed of high permeability magnetic material. Inner center conduit 203 also shows formed, wound pressure controllers 210 and 220 wrapped with multiple layers of electrical conductors 211 and 221 and or super conductors, respectively. Formed, wound pressure controllers 210 and 220 are juxtaposed next to each other on inner central conduit 203 such that when simultaneously energized the electromagnetic flux 230 created by their north (N) poles is directed towards one another. Since wound pressure controller 210 is physically larger than wound pressure controller 220, the combined electromagnetic flux 230 is directed rearward (to the right) of wound pressure controller 220. This creates a minute thrust of the entire assembly forward (to the left). The amount of thrust is proportional to the current applied to the electrical conductors 211 and 221 and or super conductors. The amount of thrust may also be controlled by changing the horizontal distance between pressure controllers 210 and 220 on inner central conduit 203.

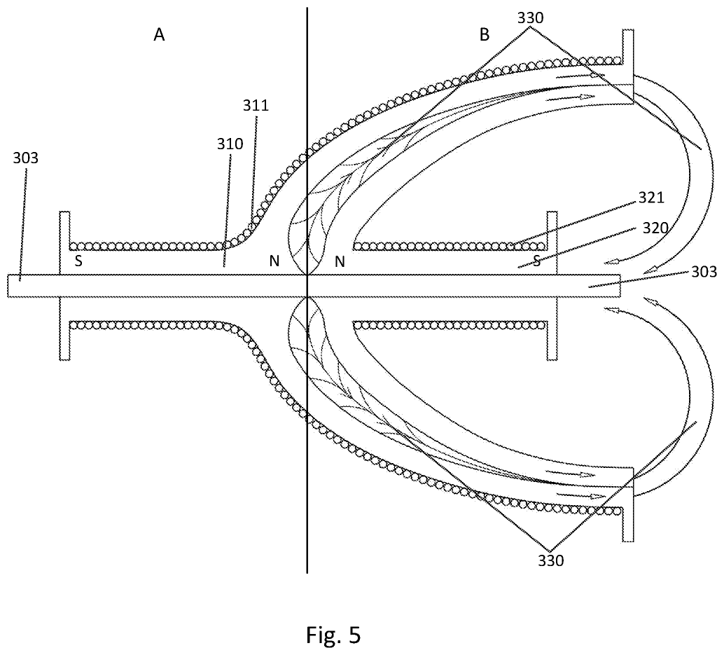

Referring now to FIG. 5, the diagram shows a side cutaway view of inner central conduit 303 with two formed, wound pressure controllers 310 and 320 affixed. Inner central conduit 303 may be threaded so that pressure controllers 310 and 320 may be placed at different locations with respect to one another on inner central conduit 303. Alternately, pressure controllers 310 and 320, may be electrically, electromechanically, or hydraulically configured to be placed at different locations with respect to one another on inner central conduit 303. Inner central conduit 303 may be constructed of high permeability magnetic material. Inner central conduit 303 also shows formed, wound pressure controllers 310 and 320 wrapped with a single layers of electrical conductors 311 and 321 and or super conductors, respectively. Those having skill in the art will recognize that formed, wound pressure controllers 310 and 320 may be wrapped with multiple layers of electrical conductors 311 and 321 and or super conductors, respectively. Formed, wound pressure controllers 310 and 320 are juxtaposed next to each other on inner central conduit 303 such that when simultaneously energized the electromagnetic flux 330 created by their north (N) poles is directed towards one another. Since wound pressure controller 310 is physically larger than wound pressure controller 320, the combined electromagnetic flux 330 is directed rearward (to the right) of wound pressure controller 320. This creates a minute thrust of the entire assembly forward (to the left). The amount of thrust is proportional to the current applied to the electrical conductors 311 and 321 and or super conductors. The amount of thrust may also be controlled by changing the horizontal distance between pressure controllers 310 and 320 on inner central conduit 303.

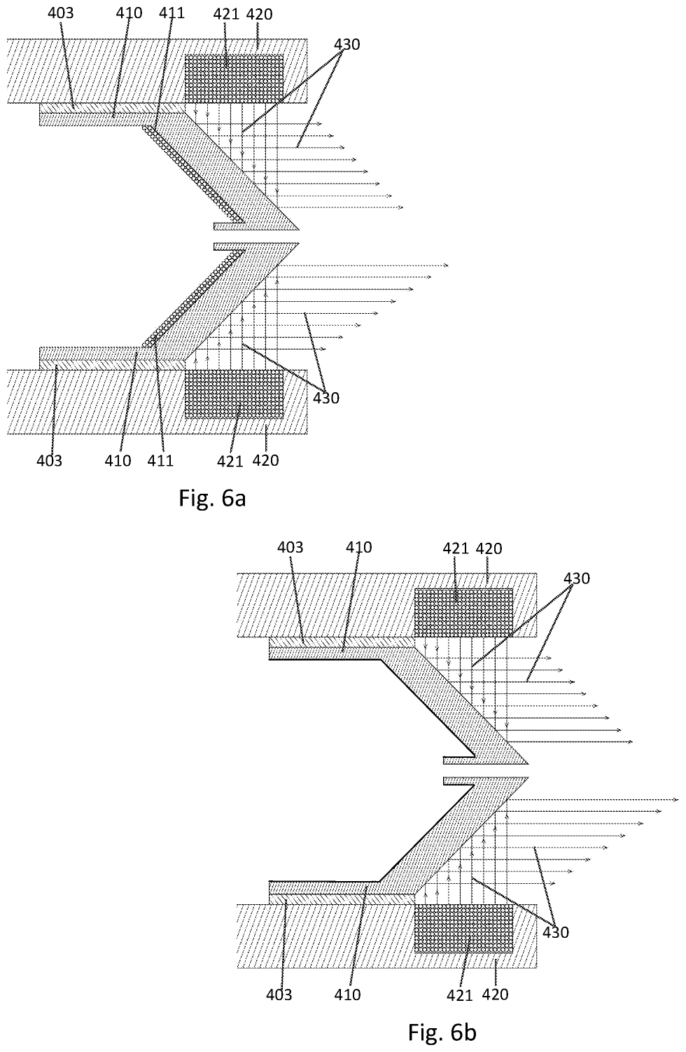

Referring now to FIG. 6a, the diagram shows a side cutaway view of cylindrical peripheral conduit 403 with two cylindrical formed, wound pressure controllers 410 and 420 affixed. Cylindrical peripheral conduit 403 may be threaded on its inside and/or outside surfaces so that cylindrical pressure controllers 410 and 420 may be placed at different locations with respect to one another on cylindrical peripheral conduit 403. Alternately, cylindrical pressure controllers 410 and 420, may be electrically, electromechanically, or hydraulically configured to be placed at different locations with respect to one another on cylindrical peripheral conduit 403. Cylindrical peripheral conduit 403 may be constructed of high permeability magnetic material. Cylindrical peripheral conduit 403 also shows formed, wound cylindrical pressure controllers 410 and 420 wrapped with multiple layers of electrical conductors 411 and 421 and or super conductors, respectively. Formed, wound cylindrical pressure controllers 410 and 420 are juxtaposed adjacent to each other inside and outside, respectively, of cylindrical peripheral conduit 403 such that when simultaneously energized the electromagnetic flux 430 created by their north (N) poles is directed towards one another. Since wound cylindrical pressure controller 410 is formed with its leading (rightmost) surface at approximately a 45° angle with respect to the central axis of cylindrical peripheral conduit 403, wound cylindrical pressure controller 410, and wound cylindrical pressure controller 420, the combined electromagnetic flux 430 is directed rearward (to the right) of cylindrical peripheral conduit 403, wound cylindrical pressure controller 410, and wound cylindrical pressure controller 420. This creates a minute thrust of the entire assembly forward (to the left). The amount of thrust is proportional to the current applied to the electrical conductors 411 and 421 and or super conductors. The amount of thrust may also be controlled by changing the horizontal distance between cylindrical pressure controllers 410 and 420 on cylindrical inner cent conduit 403.

Referring now to FIG. 6b, the diagram shows a side cutaway view of an alternative embodiment of cylindrical peripheral conduit 403 with a single cylindrical formed, wound pressure controller 420 affixed. Cylindrical peripheral conduit 403 may be threaded on its inside and/or outside surfaces so that cylindrical pressure controller 420 may be placed at different locations with respect to cylindrical thrust vectoring unit 410 on cylindrical peripheral conduit 403. Alternately, cylindrical pressure controller 420 and cylindrical thrust vectoring unit 410 may be electrically, electromechanically, or hydraulically configured to be placed at different locations with respect to one another on cylindrical peripheral conduit 403. Cylindrical peripheral conduit 403 may be constructed of high permeability magnetic material. Cylindrical peripheral conduit 403 also shows formed, wound cylindrical pressure controller 420 wrapped with multiple layers of electrical conductors 421 and or super conductors. Formed, wound cylindrical pressure controller 420 and cylindrical thrust vectoring unit 410 are juxtaposed adjacent to each other inside and outside, respectively, of cylindrical peripheral conduit 403 such that when energized the electromagnetic flux 430 created by the north (N) poles of formed, wound cylindrical pressure controller 420 is directed towards cylindrical thrust vectoring unit 410. Since cylindrical thrust vectoring unit 410 is formed with its leading (rightmost) surface at approximately a 45° angle with respect to the central axis of cylindrical peripheral conduit 403, cylindrical thrust vectoring unit 410, and wound cylindrical pressure controller 420, the electromagnetic flux 430 is directed rearward (to the right) of cylindrical peripheral conduit 403, cylindrical thrust vectoring unit 410, and wound cylindrical pressure controller 420. This creates a minute thrust of the entire assembly forward (to the left). The amount of thrust is proportional to the current applied to the electrical conductors 421 and or super conductors. The amount of thrust may also be controlled by changing the horizontal distance between cylindrical pressure controllers 420 and cylindrical thrust vectoring unit 410 on cylindrical peripheral conduit 403.

It is to be understood that the present invention is not limited to the illustrations and details shown. Those skilled in the art may modify elements and aspects described but may not deviate from the spirit and scope of the claims. For example, those having skill in the art will recognize that the direction of thrust of the elements disclosed and shown in FIGS. 4b, 5, and 6 may be essentially reversed by changing the polarity of the electrical circuit energizing the electrical conductors 211, 311, 411, 221, 321, and 421 and or super conductors. By this means, S (south) poles are juxtaposed adjacent to one another and N (north) poles are placed at the different ends of the element. Also, those having skill in the art will recognize that some of the magnetic flux 230, 330, and 430 disclosed and shown in FIGS. 4b, 5, and 6 may interact with power generation coils (not shown) to generate electric power.

Also, it will be obvious to those having skill in the art that electric power for the devices disclosed and shown in FIGS. 1, 2, 4b, 5, and 6 may be provided by several options, e.g. solar panels and/or nuclear power devices. The disclosed invention is primarily designed to function in the environment of space for space craft propulsion systems that require only electric power thereby serving as a possible alternative for long range space travel.

What is claimed:

1. An electromagnetic flux engine for spacecraft propulsion comprised of:
a) a hollow central conduit;
b) a first electromagnetic coil wherein said first electromagnetic coil is wound around the hollow central conduit;
c) at least one second electromagnetic coil wherein said second electromagnetic coil is wound inside a formed, wound pressure controller located inside said hollow central conduit wherein the axis of the formed, wound pressure controller is aligned along the axis of the central conduit;
d) a variable exhaust nozzle or a cone shaped electrical coil;
e) wherein electromagnetic flux may be accelerated through said hollow central conduit by energizing the first electromagnetic coil to direct magnetic flux through the variable exhaust nozzle or cone shaped electrical coil around the formed, wound pressure controller; and
f) wherein the variable exhaust nozzle or cone shaped electrical coil deflects and/or concentrates magnetic flux to produce thrust.

2. An electromagnetic flux engine for spacecraft propulsion of claim 1 further comprising an exterior layer capable of withstanding magnetic flux.

3. An electromagnetic flux engine for spacecraft propulsion of claim 1 wherein the hollow central conduit is constructed of a solid iron-based composite tubular nanocrystalline foil.

4. An electromagnetic flux engine for spacecraft propulsion of claim 1 wherein said formed, wound pressure controller may be constructed of non-ferrous magnetic material.

5. An electromagnetic flux engine for spacecraft propulsion of claim 1 wherein the electromagnetic magnetic flux engine is comprised of a plurality of venturi.

6. An electromagnetic flux engine for spacecraft propulsion of claim 1 wherein the electromagnetic magnetic flux engine is further comprised of a plurality of accelerating coils to amplify high velocity magnetic flux through venturi and variable exhaust nozzle or cone shaped electrical coil.

7. An electromagnetic flux engine for spacecraft propulsion of claim 1 wherein said variable exhaust nozzle or cone shaped electrical coil is constructed of non-ferrous magnetic material.

8. An electromagnetic flux engine for spacecraft propulsion of claim 1 wherein the magnetic flux engine is further comprised of electric power coils aligned within the concentrated magnetic flux to create electric power.

9. An electromagnetic flux engine for spacecraft propulsion of claim 1 wherein the magnetic flux engine comprises solar power panels.

10. An electromagnetic flux engine for spacecraft propulsion of claim 1 wherein the magnetic flux engine comprises a nuclear reactor.

11. An electromagnetic flux engine for spacecraft propulsion comprised of:
a) a central conduit;
b) a slidable adjustable first formed, wound pressure controller mounted circumferentially on the central conduit wherein the axis of the first formed, wound pressure controller coincides with the axis of the central conduit and the outermost aspect of the first formed, wound pressure controller is wound with at least one layer of electric conductor;
c) a slidable adjustable second formed, wound pressure controller mounted circumferentially on the central conduit wherein the axis of the second formed, wound pressure controller coincides with the axis of the central conduit and the innermost aspect of the second formed, wound pressure controller is wound with at least one layer of electric conductor;
d) wherein the first formed, wound pressure controller is greater in radius than the second formed, wound pressure controller and the first formed, wound pressure controller is concave at its right end and the second formed, wound pressure controller is convex at its left end;
e) wherein the first formed, wound pressure controller and the second formed, wound pressure controller are positioned adjacent to one another;
f) such that when the first formed, wound pressure controller and the second formed, wound pressure controller are electrified such that the north magnetic pole of each are juxtaposed next to each other the magnetic flux generated by the electromagnetic flux engine is directed towards the right.

12. An electromagnetic flux engine for spacecraft propulsion comprised of:
a) a peripheral conduit;
b) a slidable adjustable first formed, wound pressure controller mounted circumferentially inside the peripheral conduit wherein the axis of the first formed, wound pressure controller coincides with the axis of the peripheral conduit and the innermost aspect of the first formed, wound pressure controller is wound with at least one layer of electric conductor;
c) a slidable adjustable second formed, wound pressure controller mounted circumferentially outside of the peripheral conduit wherein the axis of the second formed, wound pressure controller coincides with the axis of the peripheral conduit and the innermost aspect of the second formed, wound pressure controller beyond the peripheral conduit is wound with at least one layer of electric conductor;
d) wherein the leading (rightmost) surface of the first formed, wound pressure controller lies at approximately a 45° angle with respect to the coincident central axes of the peripheral conduit, the second formed, wound pressure controller, and the first formed, wound pressure controller;
e) wherein the first formed, wound pressure controller and the second formed, wound pressure controller are positioned such that a line directed radially inward perpendicularly from the at least one layer of electrical conductor on the innermost aspect of the second formed, wound pressure controller contacts the leading (rightmost) surface of the first formed, wound pressure controller at approximately a 45° angle;
f) such that when the first formed, wound pressure controller and the second formed, wound pressure controller are electrified such that the north magnetic pole of each are juxtaposed next to each other such that the magnetic flux generated by the electromagnetic flux engine is directed towards the right.

13. An electromagnetic flux engine for spacecraft propulsion comprised of:
a) a peripheral conduit;
b) a slidable adjustable cylindrical thrust vectoring unit;
c) a slidable adjustable second formed, wound pressure controller mounted circumferentially outside of the peripheral conduit wherein the axis of the second formed, wound pressure controller coincides with the axis of the peripheral conduit and the innermost aspect of the second formed, wound pressure controller beyond the peripheral conduit is wound with at least one layer of electric conductor;
d) wherein the leading (rightmost) surface of the cylindrical thrust vectoring unit lies at approximately a 45° angle with respect to the coincident central axes of the peripheral conduit, the second formed, wound pressure controller, and the cylindrical thrust vectoring unit;
e) wherein the cylindrical thrust vectoring unit and the second formed, wound pressure controller are positioned such that a line directed radially inward perpendicularly from the at least one layer of electrical conductor on the innermost aspect of the second formed, wound pressure controller contacts the leading (rightmost) surface of the cylindrical thrust vectoring unit at approximately a 45° angle;
f) such that when the second formed, wound pressure controller is electrified such that its north magnetic pole is juxtaposed next to the cylindrical thrust vectoring unit the magnetic flux generated by the electromagnetic flux engine is directed towards the right.
